(19) United States
(12) Patent Application Publication
(10) Pub. No.: US 2010/0079503 A1
(43) Pub. Date: Apr. 1, 2010

(54) Color Correction Based on Light Intensity in Imaging Systems

(75) Inventors: Rajeev Ramanath, Plano, TX (US); Kirk F. Settle, McKinney, TX (US); Jeffrey M. Kempf, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/242,232

(22) Filed: Sep. 30, 2008

(51) Int. Cl. G09G 5/10

(52) U.S. Cl. 345/690

(57) ABSTRACT

In accordance with a particular embodiment of the present disclosure, color correction based on light intensity in imaging systems may be accomplished by applying a color correction data structure to color component values.

### TECHNICAL FIELD

This invention generally relates to digital color imaging systems and, more particularly, to color correction based on light intensity in imaging systems.

### BACKGROUND

Digital color imaging systems are employed in display devices such as televisions, video projectors, and computer displays. Display devices may use a variety of light sources such as high-intensity lamps or light emitting diodes (LEDs). Some lamp-based devices employ an aperture to control the black content of the display. Some LED-based devices use electrical current throttling to control of the black content.

### SUMMARY OF THE DISCLOSURE

According to certain embodiments of the present invention, disadvantages and problems associated with color correction may be reduced or eliminated.

According to certain embodiments, an apparatus for color correction based on changes in light intensity includes a memory and a color corrector. The memory stores a color correction data structure. The color corrector is configured to receive color component values, receive a light intensity instruction, and correct the color components in accordance with the light intensity instruction using the color correction data structure.

Certain embodiments may provide numerous technical advantages. Some embodiments may utilize some, none, or all of these advantages. According to some embodiments, color component values are corrected using a color correction data structure that takes into account changes in light intensity. In some cases, the data structure may yield a color component value that was calculated to minimize the effect of changes in light intensity. In other cases, the color correction data structure may yield a particular color component value for a given light intensity. As another example, the color component value may be calculated in real time based on light intensity.

Other technical advantages may be readily ascertained by one of skill in the art.

### BRIEF DESCRIPTION OF THE FIGURES

A more complete understanding of embodiments of the invention will be apparent from the detailed description taken in conjunction with the accompanying drawings, wherein like reference numbers represent like parts, in which:

FIG. 1 is a block diagram illustrating an embodiment of a digital color imaging system;

FIG. 2 is a flowchart describing the operation of an embodiment of a digital color imaging system;

FIG. 3a is a chromaticity chart illustrating an example of the variation in color gamut for a lamp-based imaging system;

FIG. 3b is a chromaticity chart illustrating an example of the variation in color gamut for an LED-based imaging system; and

FIG. 4 is a graph illustrating an example of aperture or electrical current throttling behavior as a scene moves from dark to light and light to dark.

### DETAILED DESCRIPTION OF EXAMPLE EMBODIMENTS

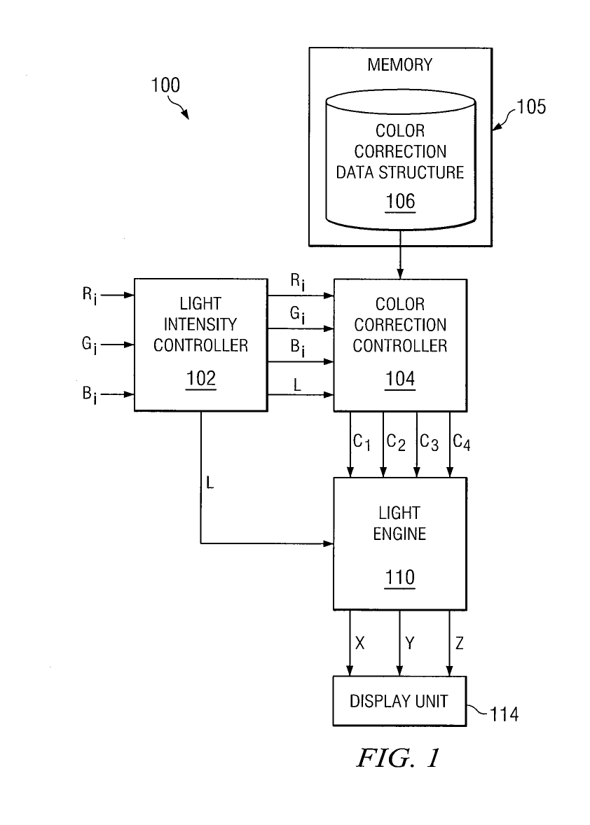

Example embodiments of the invention are best understood by referring to FIGS. 1 through 4 of the drawings, like numerals being used for like and corresponding parts of the various drawings.

FIG. 1 is a block diagram illustrating an embodiment of a digital color imaging system 100. In the illustrated embodiment, digital color imaging system 100 includes a light intensity controller 102 that is coupled to a color correction controller (or “color corrector”) 104, which may use a color correction data structure (or “lookup table”) 106 stored in a memory 105. Light intensity controller 102 and color correction controller 104 are coupled to a light engine 110, which is coupled to a display unit 114.

In certain embodiments, imaging system 100 may change the intensity of light to yield an improved rendition of a lighter or darker image. Changing the light intensity, however, may affect the accuracy of the color component values that yield the colors of the image. Accordingly, imaging system 100 may adjust the color component values to compensate for the changes in light intensity. In certain embodiments, light intensity may be adjusted differently when transitioning from dark to light than when transitioning from light to dark. Thus, color component values may be adjusted differently when transitioning from dark to light than when transitioning from light to dark.

In certain embodiments, imaging system 100 may be a component of any device configured to receive a data or video signal communicating image information and to generate an image represented by the image information. In some embodiments, imaging system 100 may be a component of a device that forms an image on a screen (such as a television or computer screen) or projects an image onto an external object (such as an external screen). Examples of devices employing imaging system 110 include a digital light processing (DLP) television, a DLP projector, a light emitting diode (LED) projector, or an LED television.

An absolute color space is one in which colors are unambiguous and the interpretations of colors in the space are defined without reference to external factors such as the display medium. A model color space, or a color gamut, represents colors defined with reference to an external factor, such as a video recording, television broadcast, or any other suitable external factor. In some cases, a mapping function may be applied to transform a model color space to an absolute color space.

Color component values represent values of colors in a color space, for example, primary colors such as red, green, and blue or cyan, magenta, yellow, and black. An example of a possible range of color component values is 0 to 255. In certain embodiments, input color component values in imaging system 100 comprise a red value Rᵢ, a green value Gᵢ, and a blue value Bᵢ, but may comprise one or more other values such as cyan, magenta, yellow, and white values. Input color component values may also comprise some combination of luma and chroma components such as Y, Cᵣ, and C_{b} or some other color space combination.

In certain embodiments, light intensity controller 102 receives input color component values for an image and determines the desired light intensity of the image. Typically, input color component values are generated by external sources such as television programming, video recordings, and/or other suitable sources. Light intensity controller 102 may generate a light intensity instruction L to instruct light engine 110 to adjust the light intensity. In certain embodiments, light intensity controller 102 sends light intensity instruction L and input color component values to color correction controller 104. An example of a light intensity controller is the Dynamic Aperture Histogram (DAH) module produced by TEXAS INSTRUMENTS, INCORPORATED (TI) for use in their DYNAMICBLACK™ product.

In certain embodiments, light intensity controller 102 adjusts intensity differently when transitioning from dark to light images than when transitioning from light to dark images. An example of the different adjustments is described in more detail with reference to FIG. 4.

In certain embodiments, color correction controller 104 receives color component values from light intensity controller 102, transforms the color component values, and sends corrected color component values to light engine 110. Color correction controller 104 may correct input color component values Rᵢ, Gᵢ, and Bᵢ to compensate for distortions in the color component values caused by changing the light intensity. In certain embodiments, color correction controller 104 may use color correction data structure 106 to correct the color component values.

In certain embodiments, color correction data structure 106 may be predetermined based on empirical data. In the embodiments, color correction data structure 106 may include mappings that associate color corrections with color component values. Color correction controller 104 may determine the color correction to apply to each color component value from the mappings. The correction may be a replacement color component value that replaces the pre-corrected color component value, or may be an adjustment that is applied to the pre-corrected color component value.

In some examples, the corrections to color component values may be independent of the value of light intensity instruction L, so the same correction may be used regardless of the light intensity instruction L. The corrections may be calculated by determining a correction that optimizes the color correction over some or all of the intensities of the light from light engine 110. While the corrections may not yield the best color at every intensity, the corrections may yield color that is optimized over at least most intensities.

The optimal corrections may be calculated in any suitable manner. For example, target color component values representing color that is optimized over at least most intensities may be determined. Pre-correction color component values representing color that would be generated by system 100 without correction may then be determined. The target and pre-correction color component values may be determined from empirical data and a graph of aperture or current settings, an example of which is described with reference to FIG. 4. Corrections that can be applied to pre-correction color component values to yield target color component values may then be determined. As another example, the corrections may be calculated by determining an individual correction that optimizes color correction for each intensity, and then calculate, from the individual corrections, a general correction that optimizes color correction over some or all of the intensities. As yet another example, the corrections may be calculated by trial and error. The corrections may be stored as one or more arrays for color component values Ri, Gi, and Bi.

In other examples, the corrections may depend on the value of light intensity instruction L, so a particular correction may be used for a given value of light intensity instruction L. A value of light intensity instruction L may include one value or a range of values. The corrections may be calculated by determining individual corrections that optimize color correction for particular values of light intensity instruction L.

The corrections may be calculated in any suitable manner. For example, target color component values representing color that is optimized at particular values of light intensity instruction L may be determined. Pre-correction color component values (describe above) may then be determined. The target and pre-correction color component values may be determined from empirical data and a graph of aperture or current settings. Corrections that can be applied to pre-correction color component values to yield target color component values may then be determined. As another example, the corrections may be calculated by trial and error.

In the examples, color correction data structure 106 may comprise one or more arrays for different values of light intensity instruction L. An array may be a series of values referenced by an index. The array corresponding to a given light intensity instruction L (the array that includes or is closest to the given light intensity instruction L) may be used to determine the correction. The arrays may comprise mappings that associate corrections with light intensity instruction L and color component values.

In certain embodiments, color correction data structure 106 may comprise one or more correction formulas. Controller 104 may use the formulas to calculate correction values for given light intensity instructions L. In certain embodiments, the formulas may comprise a series of empirical measurements of on-screen color made at maximum light intensity for a starting color and at minimum light intensity for an ending color. A three-dimensional spline curve may be constructed according to the measurements from the starting color to the ending color. The control points of the spline may be adjusted to counterbalance the effect of varying light intensity. Correction values may be calculated according to the adjusted spline curve. In the embodiments, the calculated values may be stored in memory for future reference.

In certain embodiments, the color correction formula may be represented by pseudo-code:

```
{IRE | 0 <= IRE <= 255};
        # set of min to max color code values
x0,y0 .. xn,yn = target;
        # set all points on Bezier curve to target
value
Y0 .. Yn = ?;
        # set desired End & Control points on Bezier
curve
Repeat (
    Loop from min(IRE) to max(IRE), measure & store x,y
color points;
    Loop from max(IRE) to min(IRE), measure & store x,y
color points;
    Loop through each set of x,y pairs,
        calculate & store the average deviation from
target for each pair set;
    Determine & store the MaxDev value within each set
of Bezier control points;
    Loop through each control point
        Adjust each control point by ½(avg of adjacent
pair's Max Dev values);
        I.E.  x1,y1 = x1,y1 − ½(avg(MaxDev(x0,y0  ...
x1,y1) + MaxDev(x1,y1 ... x2,y2)))
) until (
    total difference between |MaxDev| of each subset
curve < ~ 0.002,
    or loop count = defined maximum.
)
```

If convergence fails, shift Y control points to target problematic areas, then realign.

In certain embodiments, color correction for transitioning from light to dark may be determined separately from color correction for transitioning from dark to light. For example, different corrections may be calculated for the different transitions, or different formulas may be used for the different transitions.

In certain embodiments, color correction controller 104 may perform other procedures for color correction that result in the output of one or more additional or different color component values. For example, in addition to some combination of primary colors C₁, C₂, and C₃, a plurality of secondary colors and white, denoted by C₄, may be generated by color correction controller 104.

In certain embodiments, light engine 110 is configured to receive color component values such as C₁, C₂, C₃, and C₄ and transform those color component values into light which can be measured in a calorimetric space comprising components X, Y, and Z. Light engine 110 adjusts the intensity of the light generated by a light source (or “illuminator”) and emitted to display unit 114 according to light intensity instruction L.

In certain embodiments, light engine 110 may include a physical aperture configured to adjust light intensity of light generated by a high intensity lamp. The aperture may be formed from a surface of a housing of the lamp. An example of a lamp used in monitors, projectors, and televisions includes a mercury vapor arc lamp unit. In other embodiments, light engine 110 may throttle electrical current to adjust light intensity of light generated by light emitting diodes (LEDs). Examples of LEDs used in monitors, projectors, and televisions includes PHLATLIGHT LEDs, designed and manufactured by LUMINUS DEVICES. Light engine 110 may include a light modulator that modulates light from the light source. An example of a modulator is a digital micromirror device (DMD) modulator.

In certain embodiments, images are projected onto display unit 114 measured in absolute color component values X, Y, and Z. Examples of display units include CRT displays, LCD displays, and back-projection and front-projection displays, which may use high intensity lamps or on LEDs.

A component of system 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

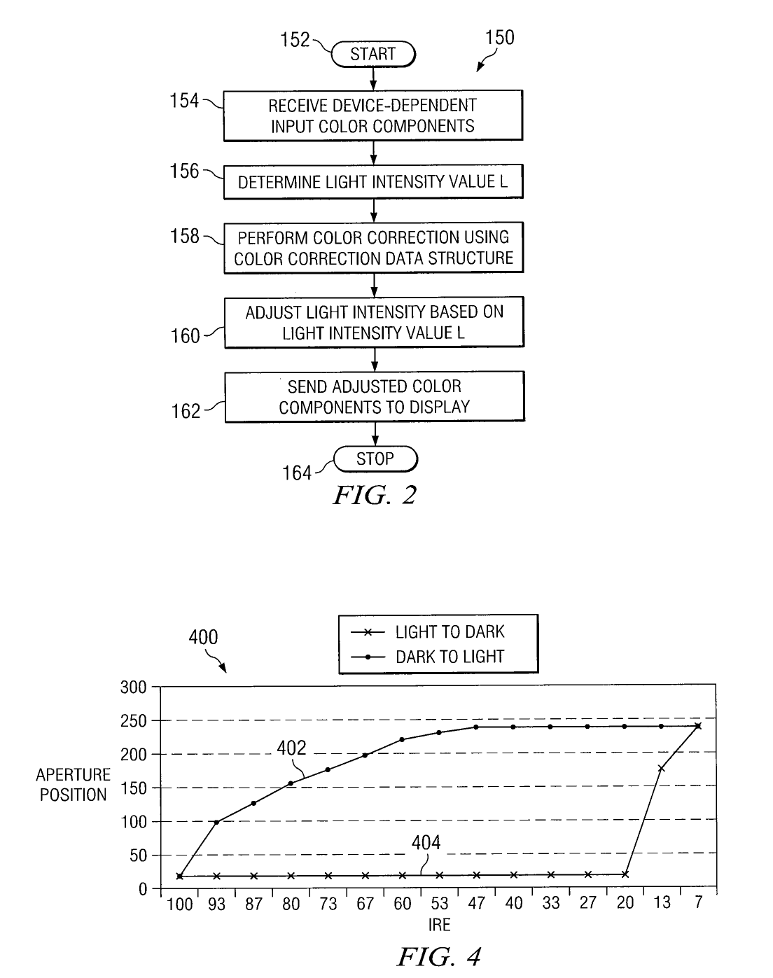

FIG. 2 is a flowchart describing a process 150 for correcting color component values distorted by adjustments to light intensity. Process 150 begins at step 152. Light intensity controller 102 receives device-dependent color component values as input parameters at step 154. In certain embodiments, the input color component values may comprise a red value Rᵢ, a green value Gᵢ, and a blue value Bᵢ, but may comprise one or more other values such as cyan, magenta, yellow, and white values.

In step 156, light intensity controller 102 determines light intensity instruction L. In step 158, controller 102 performs color correction using color correction data structure 106. In certain embodiments, color correction data structure 106 may include correction values determined from empirical data and/or functions to optimize color correction for intensities produced by system 100. In some examples, the correction values may be given independent of the value of light intensity instruction L. In other examples, specific correction values may be given for specific values of light intensity instruction L. In certain embodiments, color correction data structure 106 may include a correction function that controller 102 uses to calculate correction values for values of light intensity instruction L.

Light intensity is adjusted according to light intensity value L in step 160. Light engine 110 transforms the corrected device-dependent color component values into light which can be measured absolute color space in step 162, and sends the absolute color component values to the display. Process 150 terminates in step 164.

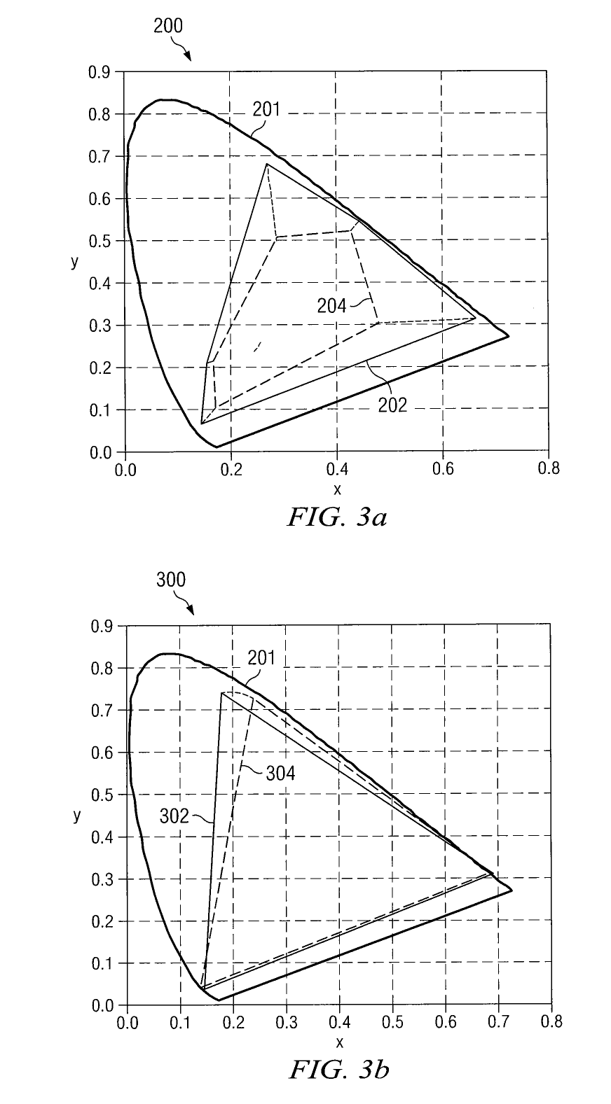

FIG. 3a is a chart 200 illustrating the variation in color gamut for a lamp-based imaging system 100 when light intensity is adjusted by opening or closing an aperture. A chromaticity chart 201 represents colors from the three-dimensional color space of human visual perception in two dimensions. The x and y axes represent how humans perceive the combination of hue and saturation. The interior of chart 201 represents the colors a human can perceive.

In certain embodiments, a polygon 202 represents the colors, or color gamut, that may be represented on a particular display unit 114 with light engine 110 operating at a particular intensity. A polygon 204 represents the color gamut of display unit 114 with light engine 110 operating at a different intensity. The difference between polygon 202 and polygon 204 shows the effect that light intensity has on the color gamut.

FIG. 3b is a chart 300 illustrating the variation in color gamut for an LED-based imaging system 100 when light intensity is adjusted by increasing or decreasing electric current to the LEDs. Chart 300 includes chromaticity chart 301. In certain embodiments, a polygon 302 represents the colors, or color gamut, that may be represented on a particular display unit 114 with light engine 110 operating at a particular intensity. A polygon 304 represents the color gamut of display unit 114 with light engine 110 operating at a different intensity. The difference between polygon 302 and polygon 304 shows the effect that light intensity has on the color gamut.

FIG. 4 is a graph 400 representing light intensity adjustments. The vertical axis represents aperture position, where zero represents a closed aperture, and 255 represents an open aperture. The horizontal axis represents luminance, and is expressed in IRE values given by the Institute of Radio Engineers (IRE). Graph 402 illustrates a dark-to-light transition, and graph 404 illustrates a light-to-dark transition. Although graph 400 represents adjusting light intensity by adjusting an aperture of light engine 110, adjusting light intensity by adjusting a current of light engine 110 may also exhibit similar behavior.

In certain embodiments, light intensity is adjusted differently when transitioning from dark to light than when transitioning from light to dark. Graph 402 shows that when transitioning from dark to light, the aperture is closed at a relatively steady rate. Graph 404 shows that when transitioning from light to dark, the aperture remains relatively constant until it reaches a low luminance, and then is rapidly opened. Typically, color correction processes do not take into account this difference in adjustments. In certain embodiments, however, color correction data structure 106 takes this difference into account.

Modifications, additions, or omissions may be made to the apparatuses described herein without departing from the scope of the invention. The components of the apparatuses may be integrated or separated. Moreover, the operations of the apparatuses may be performed by more, fewer, or other components. Additionally, operations of the apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. The methods may include more, fewer, or other steps. Additionally, steps may be performed in any suitable order.

It will be apparent that many modifications and variations may be made to embodiments of the present invention, as set forth above, without departing substantially from the principles of the present invention. Therefore, all such modifications and variations are intended to be included herein within the scope of the present invention, as defined in the claims that follow.

What is claimed is:

1. An apparatus for color tracking, the apparatus comprising:
a memory configured to store a color correction data structure; and
a color corrector configured to:
receive a plurality of color component values;
receive a light intensity instruction; and
correct the plurality of color component values in accordance with the light intensity instruction using the color correction data structure.

2. The apparatus of claim 1:
the color correction data structure comprising:
a color mapping table comprising a plurality of mappings, a mapping associating a color correction with a color component value, the color correction determined to optimize color correction with respect to light intensity; and
the color corrector configured to determine the color correction for each color component value from the mappings.

3. The apparatus of claim 1:
the color correction data structure comprising:
a color mapping table comprising a plurality of mappings, a mapping associating a color correction with the light intensity instruction and a color component value; and
the color corrector configured to determine the color correction for each color component value from the light intensity instruction and the mappings.

4. The apparatus of claim 1:
the color correction data structure comprising:
a color correction function configured to calculate an adjustment based on the light intensity instruction; and
the color corrector configured to determine the color correction for each color component value from the light intensity instruction and the color correction function.

5. The apparatus of claim 1, the light intensity instruction configured to adjust an aperture of a light engine.

6. The apparatus of claim 1, the light intensity instruction configured to adjust an electrical current of one or more illuminators of a light engine.

7. The apparatus of claim 1, the color corrector configured to correct the plurality of color component values by:
using a first adjustment if the light intensity instruction indicates increasing intensity; and
using a second adjustment if the light intensity instruction indicates a decreasing intensity, the first adjustment different from the second adjustment.

8. A method for color correction comprising:
storing color correction data in a tangible computer readable storage medium;
receiving, at a color corrector, a plurality of color component values;
receiving a light intensity instruction; and
correcting the plurality of color component values in accordance with the light intensity instruction using the color correction data.

9. The method of claim 8:
the color correction data comprising:
a lookup table comprising a plurality of mappings, a mapping associating a color correction with a color component value, the color correction determined to optimize color correction with respect to light intensity; and
further comprising determining the color correction for each color component value from the mappings.

10. The method of claim 8:
the color correction data comprising:
a lookup table comprising a plurality of mappings, a mapping associating a color correction with the light intensity instruction and a color component value; and
further comprising determining the color correction for each color component value from the light intensity instruction and the mappings.

11. The method of claim 8:
the color correction data comprising:
a color correction function configured to calculate an adjustment based on the light intensity instruction; and
further comprising determining the color correction for each color component value from the light intensity instruction and the color correction function.

12. The method of claim 8, further comprising adjusting an aperture of a light engine according to the light intensity instruction.

13. The method of claim 8, further comprising adjusting an electrical current of one or more illuminators of a light engine according to the light intensity instruction.

14. The method of claim 8, the correcting the plurality of color component values further comprising:
using a first adjustment if the light intensity instruction indicates increasing intensity; and
using a second adjustment if the light intensity instruction indicates a decreasing intensity, the first adjustment different from the second adjustment.

15. An apparatus for color tracking, the apparatus comprising:
a memory configured to store a color correction data structure;
a color corrector configured to:
receive a plurality of color component values;
receive a light intensity instruction; and
correct the plurality of color component values in accordance with the light intensity instruction using the color correction data structure; and
a light engine comprising:
a light source configured to generate light; and
a digital micromirror device (DMD) modulator configured to modulate the light.

16. The apparatus of claim 15:
the color correction data structure comprising:
a color mapping table comprising a plurality of mappings, a mapping associating a color correction with a color component value, the color correction determined to optimize color correction with respect to light intensity; and
the color corrector configured to determine the color correction for each color component value from the mappings.

17. The apparatus of claim 15:
the color correction data structure comprising:
a color mapping table comprising a plurality of mappings, a mapping associating a color correction with the light intensity instruction and a color component value; and
the color corrector configured to determine the color correction for each color component value from the light intensity instruction and the mappings.

18. The apparatus of claim 15:
the color correction data structure comprising:
a color correction function configured to calculate an adjustment based on the light intensity instruction; and
the color corrector configured to determine the color correction for each color component value from the light intensity instruction and the color correction function.

19. The apparatus of claim 15, the light intensity instruction configured to adjust an aperture of a light engine.

20. The apparatus of claim 15, the light intensity instruction configured to adjust an electrical current of one or more illuminators of a light engine.
